(19) United States
(12) Patent Application Publication
(10) Pub. No.: US 2024/0079933 A1
(43) Pub. Date: Mar. 7, 2024

(54) MOTOR WITH EXPOSED COOLING STRUCTURE

(71) Applicant: HYUNDAI MOBIS CO., LTD., Seoul (KR)

(72) Inventor: Tae Wook HA, Yongin-si (KR)

(73) Assignee: HYUNDAI MOBIS CO., LTD., Seoul (KR)

(21) Appl. No.: 18/238,148

(22) Filed: Aug. 25, 2023

(30) Foreign Application Priority Data
Sep. 1, 2022 (KR) 10-2022-0110636

(51) Int. Cl. H02K 9/19; H02K 1/276; H02K 21/14

(52) U.S. Cl. CPC H02K 9/19; H02K 1/276; H02K 21/14

(57) ABSTRACT

The present disclosure relates to a motor with an exposed cooling structure. In the motor with an exposed cooling structure, a first groove portion is formed in a rotor, a second groove portion is formed in a stator, and cooling oil injected to the second groove portion of the stator and introduced into the first groove portion of the rotor is scattered by a centrifugal force caused by rotation of a rotation shaft to cool the stator and the rotor.

### CROSS-REFERENCE TO RELATED APPLICATIONS

This application claims priority under 35 U.S.C. § 119 to Korean Patent Application No. 10-2022-0110636, filed on Sep. 1, 2022, in the Korean Intellectual Property Office, the disclosure of which is incorporated herein by reference in its entirety.

### TECHNICAL FIELD

The following disclosure relates to a motor with an exposed cooling structure, and more particularly, to a motor with an exposed cooling structure in which a first groove portion is formed in a rotor, a second groove portion is formed in a stator, and cooling oil injected to the second groove portion of the stator and introduced into the first groove portion of the rotor is scattered by a centrifugal force caused by rotation of a rotation shaft to cool the stator and the rotor.

### BACKGROUND

In general, a motor is cooled in a manner in which cooling oil is injected into the motor and comes into contact with heating elements of the motor, such as a stator and a rotor. According to the related art, the motor is also cooled in a manner in which the cooling oil injected from a nozzle or cooling pipe flows and comes into contact with the heating elements of the motor.

Recently, the cooling oil is injected into a rotation shaft, and a flow path through which the cooling oil injected into the rotation shaft may flow is formed inside the rotor of the motor to cool the rotor.

However, in a motor cooling structure according to the related art, the cooling oil injected from the nozzle or cooling pipe passes through a predetermined oil flow path and then comes into contact with the heating elements of the motor. Therefore, there is a problem in that cooling efficiency for the heating elements of the motor deteriorates as compared to a case where the cooling oil injected from the nozzle or cooling pipe directly comes into contact with the heating elements of the motor without passing through the predetermined oil flow path.

In addition, in the motor cooling structure in which the cooling oil is injected into the rotation shaft and flows to the rotor, noise and vibration occur when the rotor rotates in a case where the cooling oil is disproportionately distributed inside the rotation shaft and the flow path of the rotor.

Therefore, there is a need to develop a motor having a configuration in which the cooling oil injected from the nozzle or cooling pipe directly comes into contact with the heating elements of the motor without passing through the predetermined oil flow path, so that noise and vibration do not occur even when the rotor rotates, and the heating elements of the motor may be effectively cooled.

### SUMMARY

An embodiment of the present disclosure is directed to providing a motor in which noise and vibration do not occur when a stator and a rotor are cooled using cooling oil.

Another embodiment of the present disclosure is directed to providing a motor in which cooling oil injected from a cooling pipe directly comes into contact with a stator and a rotor without passing through a predetermined oil flow path.

Another embodiment of the present disclosure is directed to providing a motor in which a stator and a rotor may be cooled not only by cooling oil but also by air.

Aspects of the present disclosure are not limited to the above-mentioned aspects. That is, other aspects that are not mentioned may be obviously understood by those skilled in the art from the following specification.

In one general aspect, a motor with an exposed cooling structure includes: a rotation shaft extending in a length direction; a rotor including a first magnet portion, a second magnet portion, and a first groove portion, the first magnet portion including at least one cylindrical first magnet and being coupled to the rotation shaft, the second magnet portion including at least one cylindrical second magnet and being coupled to the rotation shaft while being spaced apart from the first magnet portion by a predetermined distance in the length direction, and the first groove portion being defined between the first magnet portion and the second magnet portion; a stator including a case and a coil wound in a space inside the case. A second groove portion is defined in at least a portion of the case, a discharge hole is defined in a lower portion of the case, and the rotor and a part of the rotation shaft are rotatably accommodated in the space; and a cooling pipe injecting cooling oil into the second groove portion such that the cooling oil is introduced to the first groove portion. The cooling oil introduced to the first groove portion by being injected into the second groove portion is scattered inside the stator by a centrifugal force caused by rotation of the rotor to cool the rotor and the stator, and is discharged to an outside of the stator through the discharge hole.

The second groove portion may be configured in the case such that an imaginary line segment extending from the second groove portion toward the rotation shaft in a direction perpendicular to the length direction passes through the first groove portion.

A cooling plate having a ring shape surrounding an outer circumferential surface of the rotation shaft may be disposed in the first groove portion.

A thickness of the cooling plate in the length direction may be the same as a width of the first groove portion in the length direction.

The cooling plate may have a diameter in the direction perpendicular to the length direction, and the diameter of the cooling plate may be set such that contact with the at least one cylindrical first magnet and the at least one cylindrical second magnet is prevented.

A length of the first magnet portion in the length direction may be the same as a length of the second magnet portion in the length direction.

An injection hole through which the cooling oil is injected into the second groove portion may be disposed in the cooling pipe, and the injection hole may be disposed such that the cooling oil injected into the second groove portion is introduced into the first groove portion while being prevented from coming into contact with the coil wound in the stator.

Detailed contents of other embodiments for the aspects are described in a detailed description and are illustrated in the accompanying drawings.

### BRIEF DESCRIPTION OF THE DRAWINGS

FIG. 1 is a cross-sectional view illustrating a motor with an exposed cooling structure according to an embodiment of the present disclosure.

FIG. 2 is a view illustrating a rotation shaft and a rotor coupled to the rotation shaft.

FIG. 3 is a cross-sectional view of the rotation shaft in a length direction of the rotation shaft and the rotor coupled to the rotation shaft, in which a cooling plate and a first magnet portion are visible.

FIG. 4 is a view illustrating a stator.

FIGS. 5A and 5B are cross-sectional views illustrating a cooling pipe and a flow path of cooling oil injected from the cooling pipe.

FIGS. 6A and 6B are views illustrating a state in which the cooling oil is injected into the stator from an injection hole of the cooling pipe.

### DETAILED DESCRIPTION OF EMBODIMENTS

Hereinafter, embodiments of the present disclosure will be described in detail with reference to the accompanying drawings so that they may be easily practiced by those skilled in the art to which the present disclosure pertains.

However, the present disclosure may be implemented in various different forms, and is not limited to embodiments described herein. In addition, in the drawings, portions unrelated to the description will be omitted to obviously describe the present disclosure, and similar reference numerals will be used to describe similar portions throughout the specification.

Throughout the present specification, when any one part is referred to as being “connected to” another part, it means that any one part and another part are “directly connected to” each other or are “electrically connected to” each other with the other part interposed therebetween.

Throughout the present specification, when any member is referred to as being positioned “on” another member, it includes not only a case in which any member and another member are in contact with each other, but also a case in which the other member is interposed between any member and another member.

Throughout the present specification, “including” any component will be understood to imply the inclusion of other components rather than the exclusion of other components, unless explicitly described to the contrary. In addition, terms about” and “substantially” used throughout the present specification are used for numeral values or a range close to the numerical values when inherent manufacturing and material tolerances are presented, and are used in order to prevent an unscrupulous infringer from making improper use of disclosure contents in which exact or absolute numerical values provided to assist in understanding of the present application are mentioned. The expression “step of” as used throughout the present specification does not mean “step for”.

Hereinafter, embodiments of the present disclosure will be described in detail with reference to the accompanying drawings and the following description. However, the present disclosure is not limited to the embodiments herein, but may be implemented in other forms. Same reference numerals denote same constituent elements throughout the specification.

Hereinafter, a motor with an exposed cooling structure according to an embodiment of the present disclosure will be described.

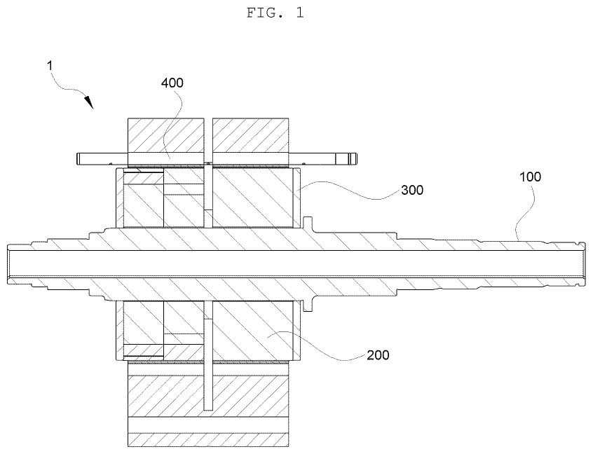

FIG. 1 is a cross-sectional view illustrating the motor with an exposed cooling structure according to an embodiment of the present disclosure.

Referring to FIG. 1, a motor 1 with an exposed cooling structure includes a rotation shaft 100, a rotor 200, a stator 300, and a cooling pipe 400.

First, the rotation shaft 100 will be described.

The rotation shaft 100 may extend in a length direction and have the same configuration as that of a rotation shaft of a motor according to the related art.

Next, the rotor 200 will be described.

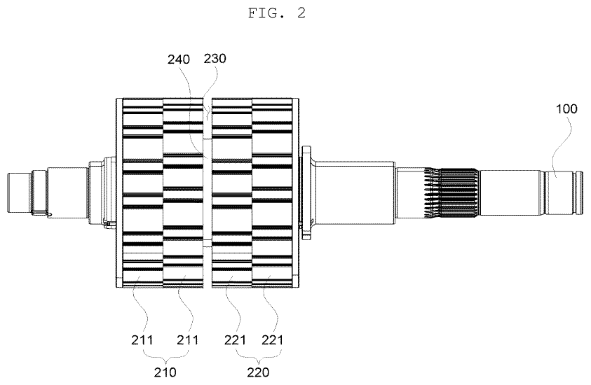

FIG. 2 is a view illustrating the rotation shaft and the rotor coupled to the rotation shaft.

Referring to FIG. 2, the rotor 200 includes a first magnet portion 210, a second magnet portion 220, and a first groove portion 230.

The first magnet portion 210 includes at least one cylindrical first magnet 211 and is coupled to the rotation shaft 100.

The second magnet portion 220 includes at least one cylindrical second magnet 221 and is coupled to the rotation shaft 100 while being spaced apart from the first magnet portion 210 by a predetermined distance in a length direction.

The first groove portion 230 is a space formed between the first magnet portion 210 and the second magnet portion 220 as the second magnet portion 220 is coupled to the rotation shaft 100 while being spaced apart from the first magnet portion 210 by the predetermined distance.

At this time, a length of the first magnet portion 210 in the length direction and a length of the second magnet portion 220 in the length direction may be the same as each other, and in a case where the first magnet portion 210 and the second magnet portion 220 are formed as described above, the first groove portion 230 is positioned in the middle of the rotor 200 in the length direction.

Meanwhile, as illustrated in FIG. 2, a cooling plate 240 may be installed in the first groove portion 230.

Specifically, the cooling plate 240 may be formed in a ring shape surrounding an outer circumferential surface of the rotation shaft 100 and may be installed in the first groove portion 230. A thickness of the cooling plate 240 in the length direction may be the same as a width of the first groove portion 230 in the length direction.

As such, in a case where the thickness of the cooling plate 240 in the length direction is the same as the width of the first groove portion 230 in the length direction, one side of the cooling plate 240 in the length direction is in contact with the first magnet portion 210, and the other side of the cooling plate 240 in the length direction is in contact with the second magnet portion 220, and thus, it is possible to more stably prevent an approach between the first magnet portion 210 and the second magnet portion 220 coupled to the rotation shaft 100 while being spaced apart from each other by the predetermined distance.

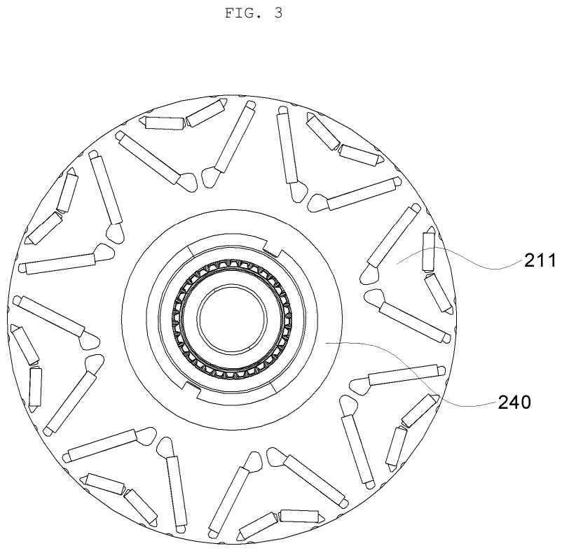

FIG. 3 is a cross-sectional view of the rotation shaft in the length direction of the rotation shaft and the rotor coupled to the rotation shaft, in which the cooling plate and the first magnet portion are visible.

Further, as illustrated in FIG. 3, the cooling plate 240 may have a diameter in a direction perpendicular to the rotation shaft 100, and the diameter of the cooling plate 240 may be set in such a way as to prevent contact with the first magnet 211.

In addition, although not illustrated in the drawings, the diameter of the cooling plate 240 may also be set in such a way as to prevent contact with the second magnet 221.

Next, the stator 300 will be described.

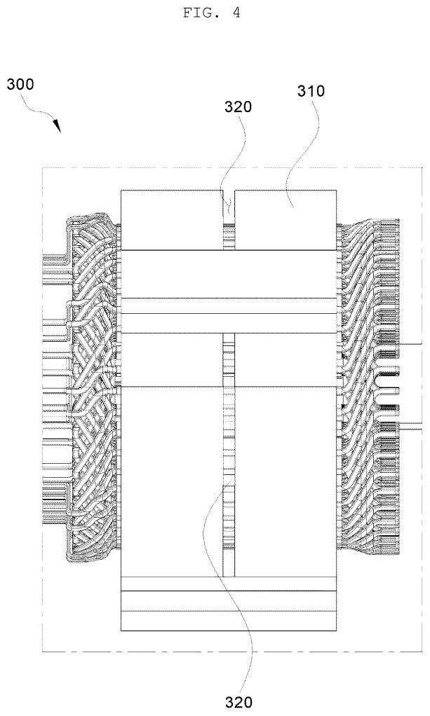

FIG. 4 is a view illustrating the stator.

Referring to FIG. 4, the stator 300 includes a case 310 and a second groove portion 320. Although not illustrated in the drawings, the stator 300 includes a coil 330 wound in a space inside the case 310.

In addition, the stator 300 accommodates the rotor 200 and a part of the rotation shaft 100 in a space formed inside the case 310 in such a way that the rotor 200 and the rotation shaft 100 are rotatable.

The case 310 may be formed as a cylindrical structure with a space formed therein.

Further, a discharge hole through which cooling oil introduced into the case 310 may be discharged to the outside of the case 310 is formed in a lower portion of the case 310.

The second groove portion 320 is a groove formed in at least a portion of the case 310 to make the inside of the case 310 and the outside of the case 310 communicate. As the second groove portion 320 is formed in the stator 300, air introduced into the case 310 from the outside of the case 310 may exchange heat with the rotor 200 and the stator 300, thereby dissipating heat from the rotor 200 and the stator 300.

The second groove portion 320 may be formed in the case 310 in such a way that an imaginary line segment that extends from the second groove portion 320 toward the rotation shaft 100 and is perpendicular to the length direction passes through the first groove portion 230.

As the second groove portion 320 is formed in this way, the cooling oil injected from a cooling pipe 400 to be described below to the second groove portion 320 may be easily introduced into the first groove portion 230.

The coil 330 may be wound in the space inside the case 310 and may have the same structure as a coil wound around a stator of a motor according to the related art.

Next, the cooling pipe 400 will be described.

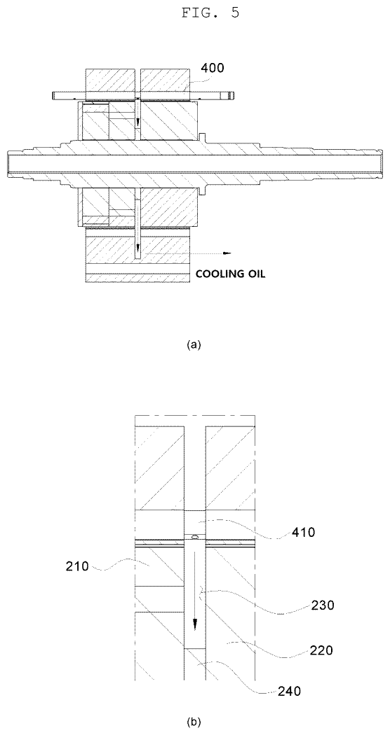

FIGS. 5A and 5B are cross-sectional views illustrating the cooling pipe and a flow path of the cooling oil injected from the cooling pipe.

Referring to FIG. 5A, the cooling pipe 400 may be disposed adjacent to an outer circumferential surface of the stator 300, and the flow path through which the cooling oil may flow is formed in the cooling pipe 400.

Further, an injection hole 410 through which the cooling oil flowing through the flow path inside the cooling pipe 400 may be injected to the outside of the cooling pipe 400 is formed at a predetermined portion of an outer circumferential surface of the cooling pipe 400.

As illustrated in FIG. 5B, the injection hole 410 may be disposed at a position where the cooling oil may be injected to the second groove portion 320 of the stator 300. The cooling oil injected through the injection hole 410 is introduced into the second groove portion 320 and then into the first groove portion 230, and in a case where the cooling plate 240 is installed in the first groove portion 230, the cooling oil comes into contact with the cooling plate 240.

Here, when the rotor 200 rotates as the rotation shaft 100 rotates, the cooling oil introduced into the first groove portion 230 or coming into contact with the cooling plate 240 may be scattered inside the stator 300 by a centrifugal force caused by the rotation of the rotor 200 to cool the rotor 200 and the stator 300, and may be discharged to the outside of the stator 300 through the discharge hole.

Meanwhile, the injection hole 410 may be disposed in such a way that the cooling oil injected to the second groove portion 320 is introduced into the first groove portion 230 while being prevented from coming into contact with the coil 330 wound in the stator 300.

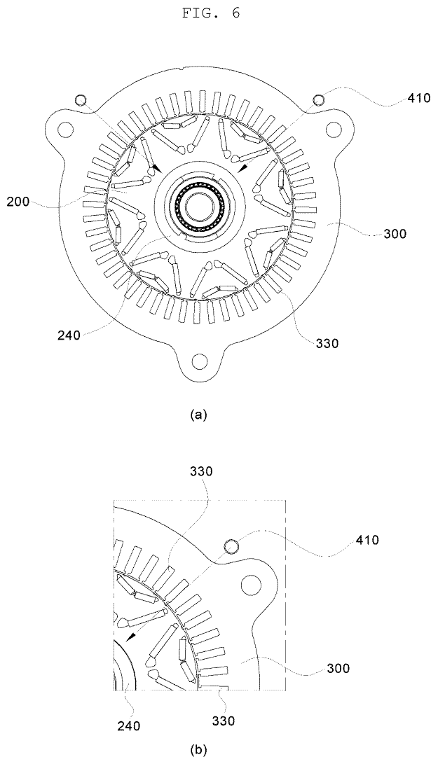

FIGS. 6A and 6B are views illustrating a state in which the cooling oil is injected into the stator from the injection hole of the cooling pipe.

Specifically, referring to FIG. 6, the cooling oil injected from the injection hole 410 may pass through the second groove portion 320 and be introduced into the first groove portion 230 (see FIG. 6A) while being prevented from coming into contact with the coil 330 (see FIG. 6B).

As described above, since the motor with an exposed cooling structure according to the present disclosure is configured in such a way that the cooling oil is injected into the stator through the second groove portion formed in the stator instead of being injected to the rotation shaft and flowing to the rotor, noise and vibration caused by the rotation of the rotor may be significantly reduced.

In addition, since the cooling oil injected from the cooling pipe is injected to the second groove portion formed in the stator, introduced into the first groove portion formed in the rotor, and then scattered to cool the stator and the rotor, the cooling oil directly comes into contact with the stator and the rotor, thereby more effectively cooling the stator and the rotor.

In addition, since air outside the stator is introduced into the stator through the second groove portion formed in the stator and exchanges heat with the rotor and the stator, the stator and the rotor are also cooled by the air, so that efficiency in cooling the stator and the rotor is improved.

The description of the present disclosure provided above is illustrative, and it is to be understood by those skilled in the art that various modifications and alterations may be made without departing from the spirit or essential feature of the present disclosure. Therefore, it is to be understood that the embodiments described above are illustrative rather than being restrictive in all aspects. For example, respective components described as a single form may be implemented in a distributed manner, and similarly, components described as being distributed may also be implemented in a combined form.

It is to be understood that the scope of the present disclosure will be defined by the claims rather than the description described above and all modifications and alterations derived from the claims and their equivalents fall within the scope of the present disclosure.

What is claimed is:

1. A motor with an exposed cooling structure, the motor comprising:
a rotation shaft extending in a length direction;
a rotor including a first magnet portion, a second magnet portion, and a first groove portion, the first magnet portion including at least one cylindrical first magnet and being coupled to the rotation shaft, the second magnet portion including at least one cylindrical second magnet and being coupled to the rotation shaft while being spaced apart from the first magnet portion by a predetermined distance in the length direction, and the first groove portion being defined between the first magnet portion and the second magnet portion;
a stator including a case and a coil wound in a space inside the case, wherein a second groove portion is defined in at least a portion of the case, a discharge hole is defined in a lower portion of the case, and the rotor and a part of the rotation shaft are rotatably accommodated in the space; and
a cooling pipe injecting cooling oil into the second groove portion such that the cooling oil is introduced into the first groove portion,
wherein the cooling oil introduced into the first groove portion by being injected to the second groove portion is scattered inside the stator by a centrifugal force caused by rotation of the rotor to cool the rotor and the stator, and is discharged to an outside of the stator through the discharge hole.

2. The motor of claim 1, wherein the second groove portion is configured in the case such that an imaginary line segment extending from the second groove portion toward the rotation shaft in a direction perpendicular to the length direction passes through the first groove portion.

3. The motor of claim 2, wherein a cooling plate having a ring shape surrounding an outer circumferential surface of the rotation shaft is disposed in the first groove portion.

4. The motor of claim 3, wherein a thickness of the cooling plate in the length direction is the same as a width of the first groove portion in the length direction.

5. The motor of claim 4, wherein the cooling plate has a diameter in the direction perpendicular to the length direction, and the diameter of the cooling plate is set such that contact with the at least one cylindrical first magnet and the at least one cylindrical second magnet is prevented.

6. The motor of claim 5, wherein a length of the first magnet portion in the length direction is the same as a length of the second magnet portion in the length direction.

7. The motor of claim 5, wherein an injection hole through which the cooling oil is injected into the second groove portion is disposed in the cooling pipe, and
the injection hole is disposed such that the cooling oil injected into the second groove portion is introduced into the first groove portion while being prevented from coming into contact with the coil wound in the stator.
